(19) United States
(12) Patent Application Publication
(10) Pub. No.: US 2023/0419108 A1
(43) Pub. Date: Dec. 28, 2023

(54) LEARNING SYSTEM AND LEARNING METHOD

(71) Applicant: Hitachi, Ltd., Tokyo (JP)

(72) Inventors: Yusei SUZUKI, Tokyo (JP); Yosuke KAGA, Tokyo (JP); Kenta TAKAHASHI, Tokyo (JP); Masakazu FUJIO, Tokyo (JP)

(21) Appl. No.: 18/117,552

(22) Filed: Mar. 6, 2023

(30) Foreign Application Priority Data
Jun. 23, 2022 (JP) 2022-101459

(51) Int. Cl. G06N 3/08; G06N 3/045; H04L 9/08; G06F 21/32

(52) U.S. Cl. CPC G06N 3/08; G06N 3/045; H04L 9/0863; G06F 21/32

(57) ABSTRACT

A training server classifies a common model and an individual model transmitted from a plurality of client devices on the basis of the individual model transmitted from a training data management server, and updates the common model and the individual model in accordance with a classification result.

### CROSS-REFERENCE TO RELATED APPLICATION

The present application claims priority from Japanese application JP2022-101459, filed on Jun. 23, 2022, the contents of which is hereby incorporated by reference into this application.

### BACKGROUND OF THE INVENTION

### 1. Field of the Invention

The present invention relates to a learning system and a learning method.

### 2. Description of the Related Art

A biometric authentication technology performing individual authentication on the basis of the image of the face, the fingerprint, the iris, or the like has been widespread. Among them, an authentication accuracy of the face authentication has been greatly improved by using deep learning. On the other hand, a large amount of face images is required for the learning of a face authentication model.

Recently, a system relevant to privacy protection has been prepared, and thus, it is difficult to collect biometric information including the face image. In order to solve such a problem, a technology referred to as associative learning in which a model is updated without collecting learning data by performing the learning in a client device and by sharing only the parameter of the model after learning has attracted attention.

In addition, for the biometric authentication technology, a difference in an authentication accuracy between individuals having different attributes such as the gender or the color of the skin has attracted attention. In the research of National Institute of Standards and Technology (NIST), performed in 2019, it is reported that a false recognition rate is greatly different between individuals due to a difference in the gender or the color of the skin, and there is also a case where a plurality of companies stop providing the face authentication technology.

On the other hand, an associative learning method for individual authentication in which a difference (fairness) in the authentication accuracy between the individuals having different attributes such as the gender or the color of the skin is considered has not been proposed.

In Yahya H. Ezzeldin, Shen Yan, Chaoyang He, Emilio Ferrara, Salman Avestimehr, “FairFed: Enabling Group Fairness in Federated Learning,” 35th Conference on Neural Information Processing Systems Workshop, 2021.<https://arxiv.org/abs/2110.00857>, an associative learning method of a binary classification model for reducing a difference in a classification accuracy between individuals having different attributes is proposed. In Yahya H. Ezzeldin, Shen Yan, Chaoyang He, Emilio Ferrara, Salman Avestimehr, “FairFed: Enabling Group Fairness in Federated Learning,” 35th Conference on Neural Information Processing Systems Workshop, 2021.<https://arxiv.org/abs/2110.00857>, a learning method for reducing a difference in a classification accuracy between users having different attributes by adjusting weight on the basis of an index relevant to fairness in a client device in addition to the number of data pieces that can be used in the client device is proposed.

In Afroditi Papadaki, Natalia Martinez, Martin Bertran, “Federating for Learning Group Fair Models”, 35th Conference on Neural Information Processing Systems Workshop, 2021.<https://arxiv.org/abs/2110.01999>, in associative learning of a class classification model, a learning method for updating the parameter of a model by weighting according to a statistical risk between attributes is proposed.

In Divyansh Aggarwal, Jiayu Zhou, Anil K. Jain, “FedFace: Collaborative Learning of Face Recognition Model,” International Joint Conference on Biometrics 2021. <https://arxiv.org/pdf/2104.03008.pdf>, a method for performing associative learning of a face authentication model is proposed.

In Sixue Gong Xiaoming Liu Anil K. Jain, “Mitigating Face Recognition Bias via Group Adaptive Classifier,” Conference on Computer Vision and Pattern Recognition, 2021. <https://openaccess.thecvf.com/content/CVPR2021/papers/Gong_Mitigating_Face_Recognition_Bias_via_Group_Adaptive_Classifier_CVPR_2021_paper.pdf>, in deep learning of a face authentication model performed in a general environment, which is not associative learning, a method for reducing a difference in an authentication accuracy between individuals having different attributes is proposed.

### SUMMARY OF THE INVENTION

In Yahya H. Ezzeldin, Shen Yan, Chaoyang He, Emilio Ferrara, Salman Avestimehr, “FairFed: Enabling Group Fairness in Federated Learning,” 35th Conference on Neural Information Processing Systems Workshop, 2021.<https://arxiv.org/abs/2110.00857>, it is not possible to calculate a difference in the authentication accuracy between the users having different attributes in the client device. Accordingly, a difference occurs in the authentication accuracy between the individuals having different attributes.

In Afroditi Papadaki, Natalia Martinez, Martin Bertran, “Federating for Learning Group Fair Models”, 35th Conference on Neural Information Processing Systems Workshop, 2021.<https://arxiv.org/abs/2110.01999>, it is not possible to calculate the degree of similarity with another person, and thus, it is not possible to calculate the false recognition rate that is the statistical risk. Accordingly, a difference occurs in the authentication accuracy between the individuals having different attributes.

In Divyansh Aggarwal, Jiayu Zhou, Anil K. Jain, “FedFace: Collaborative Learning of Face Recognition Model,” International Joint Conference on Biometrics 2021. <https://arxiv.org/pdf/2104.03008.pdf>, the attribute of the user is not considered. Accordingly, in a case where there is a biased attribute in data when performing learning, a difference occurs in the authentication accuracy between the individuals having different attributes.

In Sixue Gong Xiaoming Liu Anil K. Jain, “Mitigating Face Recognition Bias via Group Adaptive Classifier,” Conference on Computer Vision and Pattern Recognition, 2021. <https://openaccess.thecvf.com/content/CVPR2021/papers/Gong_Mitigating_Face_Recognition_Bias_via_Group_Adaptive_Classifier_CVPR_2021_paper.pdf>, a situation peculiar to the associative learning for individual authentication is not considered. Accordingly, a difference occurs in the authentication accuracy between the individuals having different attributes.

An object of the invention is to reduce a difference in an authentication accuracy between individuals having different attributes by associative learning, in a learning system.

A learning system of one aspect of the invention is a learning system updating a model on the basis of learning data, the system including: a plurality of client device; a training data management server; and a training server, in which the training server manages a common model, the client device and the training data management server manage individual data, generate an individual model different for each individual from the common model and the individual data, share the common model and the individual model with the training server, and receive the common model from the training server, update the common model and the individual model on the basis of the individual data, and transmit the updated common model and individual model to the training server, and the training server classifies the common model and the individual model transmitted from the plurality of client devices on the basis of the individual model transmitted from the training data management server, and updates the common model and the individual model in accordance with a classification result.

According to one aspect of the invention, it is possible to reduce a difference in the authentication accuracy between the individuals having different attributes by the associative learning, in the learning system.

### BRIEF DESCRIPTION OF THE DRAWINGS

FIG. 1 is a diagram illustrating a configuration of a learning system of a first example;

FIG. 2 is a diagram illustrating an example of a procedure of associative learning processing for individual authentication;

FIG. 3 is a diagram illustrating an example of a procedure of individual data collection processing;

FIG. 4 is a diagram illustrating an example of a procedure of learning processing in a server;

FIG. 5 is a diagram illustrating an example of a procedure of the learning processing in a client device;

FIG. 6 is a diagram illustrating an example of a procedure of model update processing;

FIG. 7 is a diagram illustrating an example of a procedure of individual model storage processing in a training data management server;

FIG. 8 is a diagram illustrating an example of a procedure of the individual model storage processing in the client device;

FIG. 9 is a diagram illustrating an example of a procedure of individual authentication processing;

FIG. 10 is the diagram illustrating a hardware configuration of a learning system;

FIG. 11 is a diagram illustrating a configuration of a learning system of a second example;

FIG. 12 is a diagram illustrating a configuration of a learning system of a third example;

FIG. 13 is a diagram illustrating an example of a classification method of a client;

FIG. 14 is a diagram illustrating an example of aggregation of a common model; and

FIG. 15 is a diagram illustrating an example of optimization of an individual model.

### DETAILED DESCRIPTION OF THE PREFERRED EMBODIMENTS

Hereinafter, examples will be described by using the drawings.

### FIRST EXAMPLE

A first example is a machine learning system in which a client device shares an individual model generated from individual data with a training server, a plurality of individual models generated by a training data management server are shared with the training server, the training server classifies the individual model received from each of the client devices by using the individual model received from the training data management server, a common model and the individual model are optimized on the basis of a classification result, and then, the individual model is shared with the client device and the training data management server.

Hereinafter, the procedure will be described with reference to the drawings.

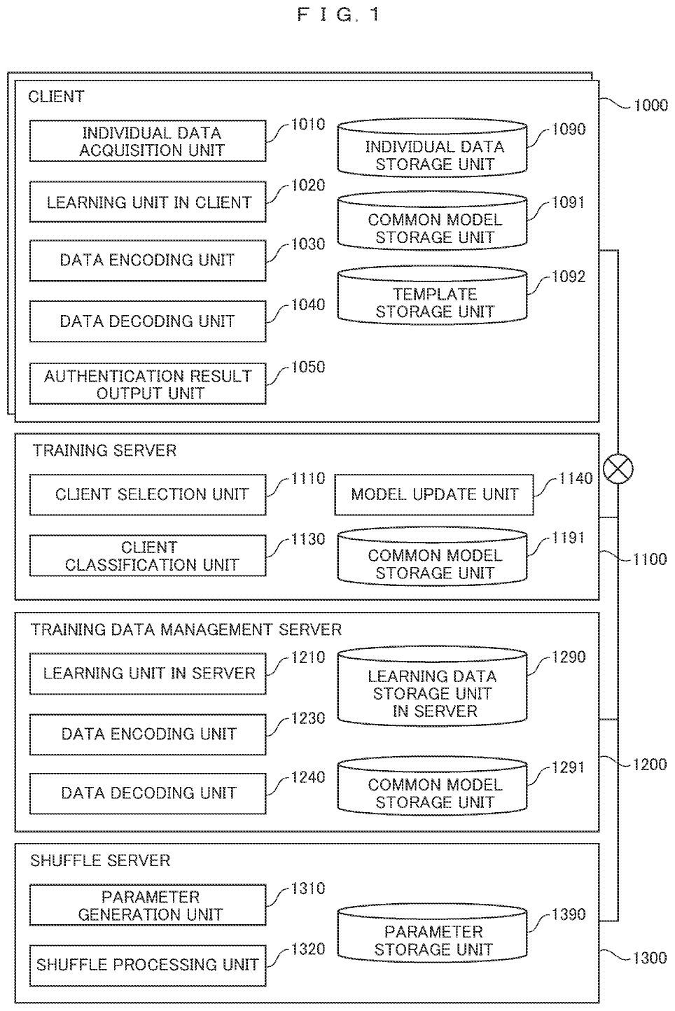

FIG. 1 is a diagram including a configuration example of the client device, the training server, and the training data management server.

In FIG. 1, 1000 is a client device, and includes an individual data acquisition unit 1010, a learning unit 1020 in the client device, a data encoding unit 1030, a data decoding unit 1040, an authentication result output unit 1050, an individual data storage unit 1090, a common model storage unit 1091, and a template storage unit 1092. Hereinafter, each unit will be described.

The individual data acquisition unit 1010 acquires data associated with an individual from an individual. The learning unit 1020 in the client device performs learning of the common model and the individual model, on the basis of the individual data acquired by the individual data acquisition unit 1010. The data encoding unit 1030 encodes the individual data or the individual model to prevent an individual information leakage.

The data decoding unit 1040 decodes the individual data or the individual model encoded by the data encoding unit 1030, and extracts the original data. The authentication result output unit 1050 outputs the result of individual authentication using the individual data.

The individual data storage unit 1090 stores the individual data or the individual model. The common model storage unit 1091 stores the learned common model to utilize in the individual authentication. The template storage unit 1092 creates a template for registration that is used when performing the individual authentication. Note that, in this first example, one or more client devices are included in processing.

1100 is a training server, and includes a client device selection unit 1110, a client device classification unit 1130, a model update unit 1140, and a common model storage unit 1191. Hereinafter, each unit will be described.

The client device selection unit 1110 selects a client device that participates in the current learning round from client devices that are capable of participating in the learning.

The client device classification unit 1130 classifies each of the client devices, on the basis of the individual model received from the client device, the individual model received from the training data management server, and attribute information such as the gender or the color of the skin.

The model update unit 1140 updates the weight of the common model and the individual model. The update of the weight is attained by defining a loss function with respect to the model, and by minimizing the loss function.

The common model storage unit 1191 stores the learned common model. Note that, the function of the training server can also be performed by the same terminal as the training data management server.

1200 is a training data management server, and includes a learning unit 1210 in the server, a data encoding unit 1230, a data decoding unit 1240, a learning data storage unit 1290 in the server, and a common model storage unit 1291. Hereinafter, each unit will be described.

The learning unit 1210 in the server updates the common model and the plurality of individual models, on the basis of the learning data stored in the learning data storage unit 1290 in the server.

The data encoding unit 1230 encodes the learning data or the individual model to prevent an individual information leakage. The data decoding unit 1240 decodes the learning data or the individual model encoded by the data encoding unit 1230, and extracts the original data.

The learning data storage unit 1290 in the server stores the data used when performing learning in the server and the individual model corresponding thereto.

The common model storage unit 1291 stores the learned common model.

Note that, the function of the training data management server can also be performed by the same terminal as the training server.

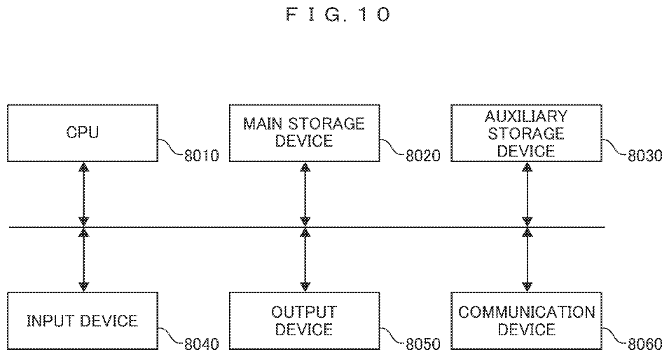

Next, a hardware configuration of the client device 1000, the training server 1100, the training data management server 1200, and a shuffle server 1300 will be described with reference to FIG. 10.

In FIG. 10, 8010 is a central processing unit (CPU), 8020 is a main storage device, 8030 is an auxiliary storage device, 8040 is an input device, 8050 is an output device, and 8060 is a communication device.

The CPU 8010 executes programs corresponding to the learning unit 1020 in the client device, the data encoding unit 1030, the data decoding unit 1040, the client device selection unit 1110, the model update unit 1140, and the parameter generation unit 1210.

The main storage device 6020 is a device corresponding to a memory of a computer, and stores the programs corresponding to the learning unit 1020 in the client device, the data encoding unit 1030, the data decoding unit 1040, the client device selection unit 1110, the model update unit 1140, and the parameter generation unit 1210. By executing such programs in the CPU 8010, each processing is attained.

A part or all of the programs or data may be stored in advance in the main storage device 6020, or may be introduced from a non-transitory storage medium or an information processing device including the external non-transitory storage device through a network.

The auxiliary storage device 8030 is a storage device that is represented by a hard disk drive (HDD), a solid state drive (SSD), or the like, and corresponds to the individual data storage unit 1090, the common model storage unit 1091, the template storage unit 1092, the common model storage unit 1190, and the parameter storage unit 1290. The data stored in each unit is accumulated as data on the auxiliary storage device 8030.

The input device 8040 is used to read information in the individual data acquisition unit 1010. The input device 8040 may include a device such as a keyboard, a biometric sensor, a touch panel, a smart device, a scanner, and a camera.

The output device 8050 is used to output the information through a device such as a display in the authentication result output unit 1050.

The communication device 8060 is used for communication between the client device 1000, the training server 1100, and the training data management server 1200.

As described above, in the first example, it is possible to construct a high-accuracy common model while reducing a difference in an authentication accuracy between attributes.

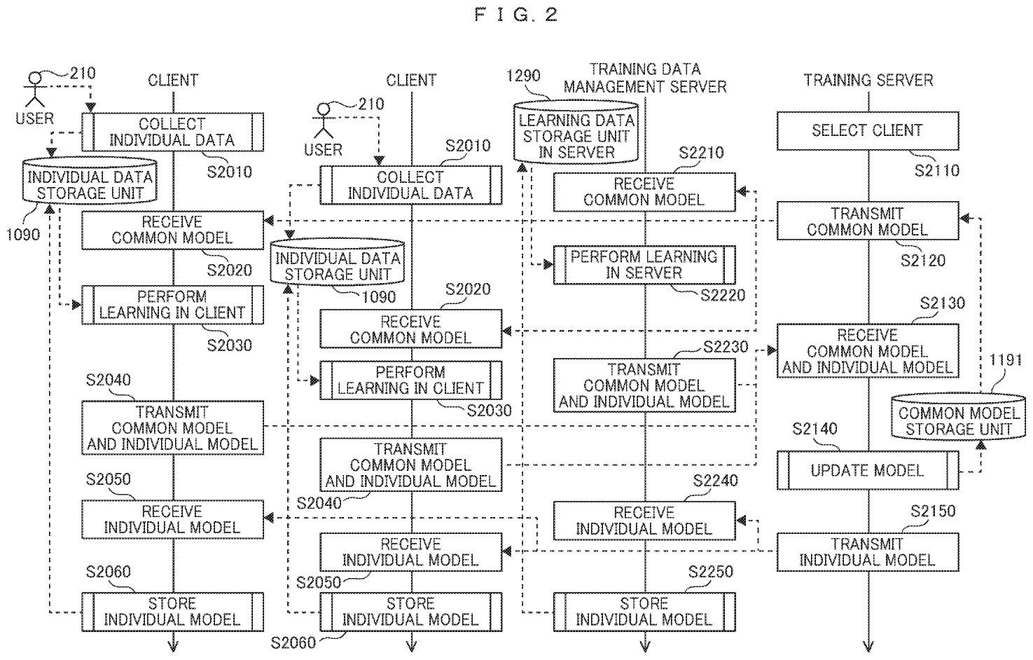

A processing procedure of this first example will be described with reference to FIG. 2 to FIG. 8.

FIG. 2 is a diagram illustrating an example of the procedure of associative learning processing for individual authentication considering fairness. Hereinafter, each procedure will be described. Associative learning of the model that is used in the individual authentication is performed by the client device 1000, the training server 1100, and the training data management server.

First, the individual data acquisition unit 1010 in the client device 1000 collects the individual data from a user 210 (S2010).

The individual data is data used in the individual authentication that is a target in this example, and for example, includes physical information such as the fingerprint, the face, the iris, and the vein, or a behavioral characteristic such as acceleration information, a movement history, a browse history, and a purchase history.

The individual data may be acquired only in order to collect the data, or may be acquired by accumulating the individual data acquired for the authentication.

By repeating S2010, the individual data of the user 210 is accumulated in the client device. Note that, in a case where the client device is occupied by one user, the individual data for one specific user is accumulated, but the invention is not limited thereto.

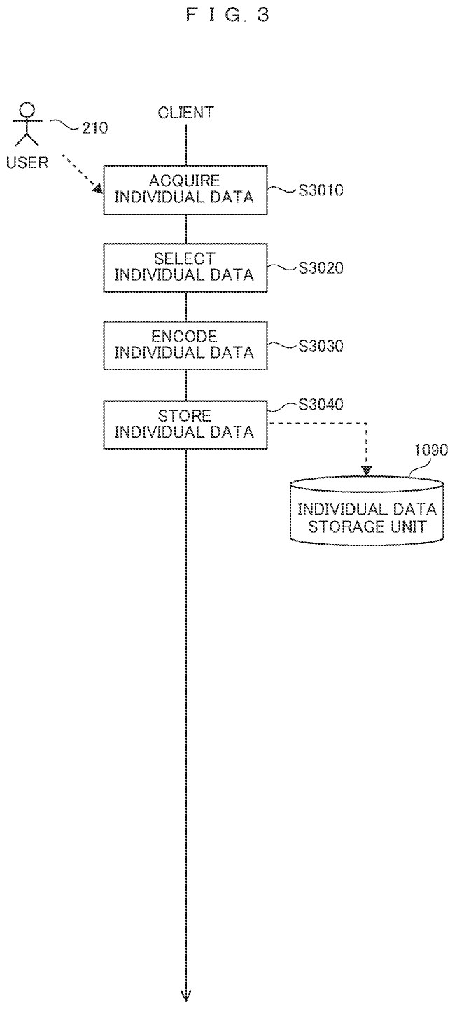

For example, the individual data of a plurality of people may be accumulated in the client device shared by the plurality of people, or the individual data accumulated by a plurality of other client devices may be aggregated in the client device to use in the associative learning. The details of S2010 will be described below with reference to FIG. 3.

The training server 1100 selects the client device that participates in the learning in each round by the client device selection unit 1110 (S2110).

As a method for selecting the client device, a method for selecting all the client devices, a method for randomly selecting a statically or dynamically set number of client devices from the client devices that are capable of participating in the learning, a method for setting a certain evaluated value with respect to the client device and for selecting a client device at the top or bottom of the evaluated value, a method for selecting a client device having an evaluated value that is greater or less than or equal to a certain threshold value, a method for selecting a client device after adding weight according to the evaluated value, and the like can be adopted.

The training server 1100 transmits the common model stored in the common model storage unit 1191 to each of the participate client devices (S2120).

The common model is a machine learning model that inputs the individual data and outputs a characteristic vector, and a general machine learning model such as a linear regression model, a decision tree, and a neural network can be applied.

For example, in the case of using image data of such as the fingerprint, the face, the iris, the vein, or the like as the individual data, a deep learning model such as convolutional neural networks (CNN) or Transformer can be applied.

Note that, the common model may be initialized with random weight when starting the learning, or may be preliminarily learned by using individual data different from that stored in the client device to be optimized with the weight thereof.

The training data management server 1200 receives the common model from the training server 1100 (S2210), and utilizes the data stored in the learning data storage unit in the server in the learning unit 1210 in the server to update the common model and the individual model in the server (S2220).

The common model is a machine learning model as described in S2120. The individual model in the server is a model different for each individual or each attribute.

Here, the attribute indicates the characteristic of the individual such as the gender or the color of the skin.

For example, in distance learning in which the characteristic vector is extracted from the individual data, and a distance between the characteristic vectors reflects similarity between the individual data pieces, a representative vector of the characteristic vector can be used as the individual model in the server.

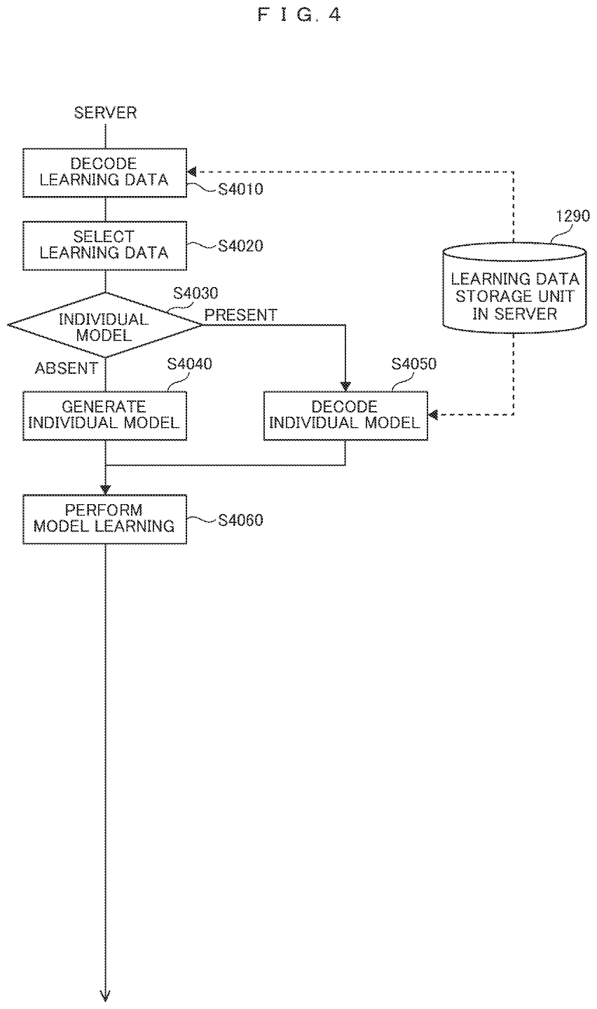

In addition, in the case of setting the individual model for each attribute, a representative vector in the case of combining the representative vectors with each attribute can also be used. The details of model update according to the learning in the server will be described below with reference to FIG. 4.

The training data management server 1200 transmits the common model and the individual model as a learning result to the training server 1100 (S2230). The client device 1000 receives the common model from the training server 1100 (S2020), and utilizes the individual data in the learning unit 1020 in the client device to update the common model and the individual model (S2030).

The common model is a machine learning model as described in S2120. The individual model is a model different for each individual. In a case where only the individual data for one person is stored in the device terminal, there is one individual model in the client device.

For example, in the distance learning in which the characteristic vector is extracted from the individual data, and a distance between the characteristic vectors reflects the similarity between the individual data pieces, the representative vector of the characteristic vector can be used as the individual model.

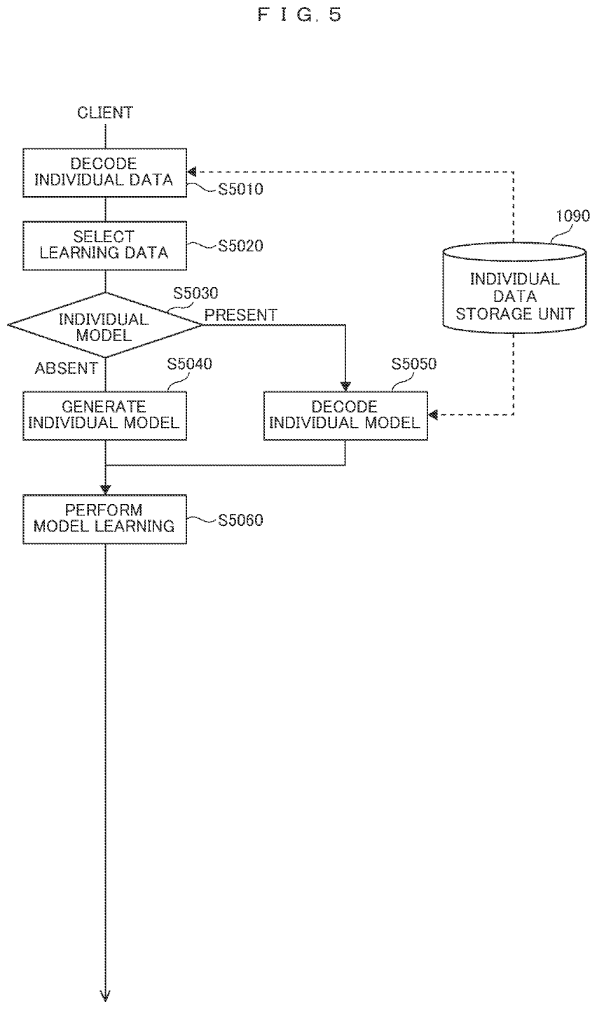

The representative vector is sensitive information associated with the user of the client device, and in a case where the data is obtained by a third person, there is a risk of impersonation or an individual data leakage. The details of model update according to the learning in the client device will be described below with reference to FIG. 5.

The client device 1000 transmits the common model and the individual model as the learning result to the training server 1100 (S2040). Note that, in a case where the learning result is directly transmitted to the training server 1100 from the client device 1000, the training server 1100 grasps from which client device the common model and individual model are transmitted.

In this case, when some individual information is leaked from the common model or the individual model, the client device corresponding to the leaked individual information is specified.

In order to prevent such a problem, when transmitting the learning result to the training server 1100 from the client device 1000, by interposing the shuffle server between the training server and the client device, it is also possible for the shuffle server to perform order shuffle or the application of a different identifier with respect to the data that has been transmitted from the client device 1000.

Accordingly, it is not possible to grasp a correspondence relationship between the data received from the training server 1100 and the client device 1000, and it is possible to attain high safety.

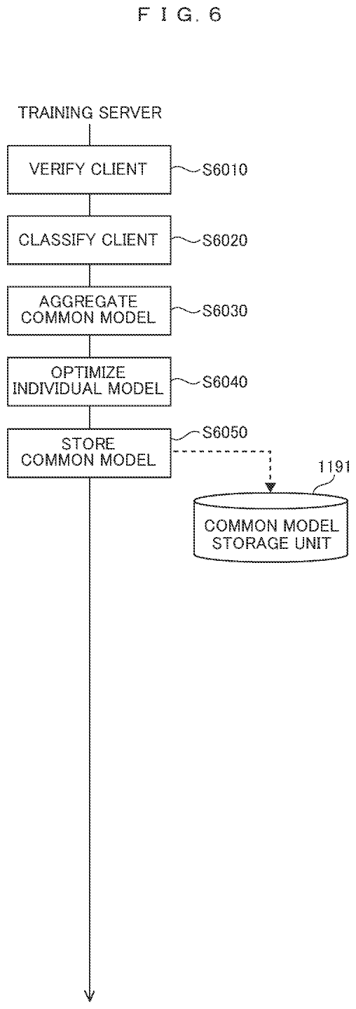

The training server 1100 receives the common model and the individual model from a plurality of client devices 1000 and the training data management server 1200, and performs the aggregation of the common model and the optimization of the individual model in the model update unit 1140 (S2140). The details of S2140 will be described below with reference to FIG. 6.

The training server 1100 transmits the individual model updated in S2140 to each of the client devices and the training data management server (S2150). In this case, there is the individual model for each client device and each training data management server, the individual model is transmitted only to the corresponding client device and training data management server when transmitting the individual model. In a case where the individual model is transmitted to a different client device or a different training data management server, there is a risk of impersonation or individual data presumption by using the individual model.

The training data management server 1200 stores the individual model received from the training server 1100 in the learning data storage unit 1290 in the server (S2250).

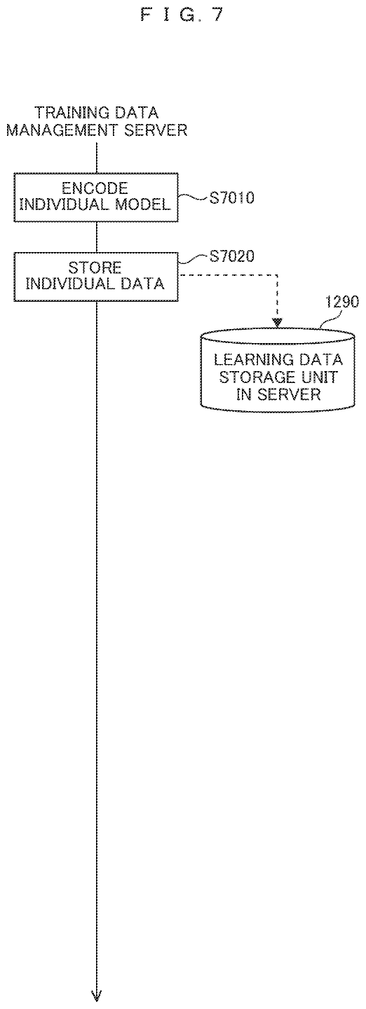

Individual model storage will be described below with reference to FIG. 7.

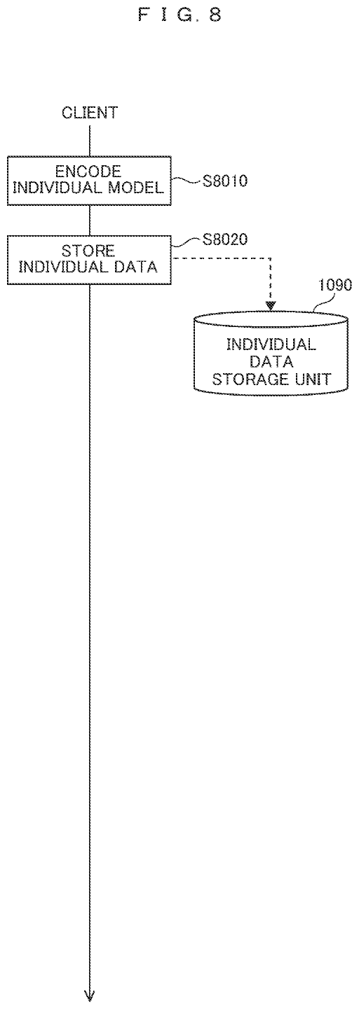

The client device 1000 stores the individual model received from the training server 1100 (S2050) in the individual data storage unit 1090 (S2060). The individual model storage will be described below with reference to FIG. 8.

As described above, it is possible to perform the associative learning of the common model in the training server while reducing a difference in the authentication accuracy between the client devices.

Next, a processing procedure of individual data collection S2010 will be described with reference to FIG. 3.

First, the individual data is acquired from the user 210 (S3010).

The individual data, as described above, for example, includes the physical information such as the fingerprint, the face, the iris, and the vein, or the behavioral characteristic such as the acceleration information, the movement history, the browse history, and the purchase history.

Next, the individual data acquired in S3010 is selected (S3020). In S3020, data used in the associative learning is selected from the individual data acquired in S3010.

It is also possible to use all the acquired individual data pieces in the learning without performing S3020, but it is possible to reduce a calculation amount of the learning or a storage capacity of the individual data storage unit 1090 by selecting the data to reduce the individual data.

In addition, by excluding the individual data that contributes less to the learning or the individual data having a negative influence, it is possible to expect an improvement in the accuracy of the common model to be finally obtained.

The selection of the individual data is performed by calculating evaluated value for each individual data piece, and by selecting the individual data of which the evaluated value is greater or equal to or less than a certain threshold value, the individual data at the top or bottom of the evaluated value, or the individual data of which the evaluated value is in a certain range.

Note that, it is also possible to select the individual data by calculating the evaluated value with respect to a distance between the individual data pieces or a set of individual data pieces without calculating the evaluated value for each individual data piece, and by repeating the exclusion of the individual data on the basis of the evaluated value.

For example, in the case of using the face image as the individual data, the face images that appear on a moving image are extremely similar to each other in each frame, and thus, even in the case of learning a large amount of similar face images, an efficiency is degraded and an accuracy is not high.

In addition, a face image in which the face is looking at side, the face is covered with the hand, or the face protrudes from the image has an overlarge error, and thus, is not suitable as the learning data.

In order to exclude such individual data, for example, characteristic extraction is performed for each face image to generate the characteristic vector, and in a case where the distance between the characteristic vectors is sufficiently short, that is, in a case where the face images are sufficiently similar to each other, one face image is excluded from the learning data, and thus, similar individual data can be excluded.

In addition, it is possible to exclude inadequate individual data by calculating a quality value including the direction of the face or the presence or absence of the covered face from the face image, the presence or absence of the protrusion, and the like, and by excluding the face image of which the quality value is greater than or equal to or less than a certain value.

The client device 1000 encodes the individual data selected in S3020 by the data encoding unit 1030 (S3030).

The encryption is performed in order to prevent the individual data leakage due to an unauthorized access of third person to the client device, malware infection, or the like.

Note that, in a case where the client device can be trusted or in a case where the safety of the client device is ensured by a method other than the data encryption, the data encryption may not be performed.

When performing the encryption, in general, a private key is required. Such a private key can be managed by the storage device in the client device, a safe region in the client device such as a trusted execution environment (TEE), an external medium such as a hardware token, and the like.

Note that, by using a biometric cryptography such as a Fuzzy Extractor, it is also possible to dynamically generate the private key from individual data such as biometric information.

In this case, insofar as the private key can be dynamically generated from individual data of a learning target of this example, it is not necessary to prepare the private key for encryption, and the private key is dynamically generated from the individual data obtained in order to perform the individual authentication or to acquire the individual data, and the encryption can be performed by using the private key.

The individual data encoded in S3030 is stored in the individual data storage unit 1090 (S3040).

As described above, the individual data is acquired from the user 210, is encoded into a safe form, and then, can be stored in the individual data storage unit 1090.

Next, a processing procedure of the learning S2220 in the server will be described with reference to FIG. 4.

First, the learning data stored in the learning data storage unit 1290 of the training data management server 1200 is decoded (S4010). The private key when performing the encryption is required for the decryption of the learning data.

Such a private key can be managed by the storage device in the training server, a safe region in the training server such as a trusted execution environment (TEE), an external medium such as a hardware token, and the like.

The learning data is data used in the individual authentication that is the target in this example, and for example, includes the physical information such as the fingerprint, the face, the iris, and the vein, or the behavioral characteristic such as the acceleration information, the movement history, the browse history, and the purchase history.

Note that, it is not necessary that such data is collected from the individual, and the data may be data that is artificially generated or data that is synthesized from data of a plurality of people by a statistical operation.

Next, the learning data used in the learning in the server is selected from the data stored in the learning data storage unit 1290 in the server (S4020).

The learning data can be selected by randomly extracting a predetermined number of learning data pieces from the learning data in the server.

Note that, the learning data can also be selected by calculating the evaluated value for each learning data piece, and by selecting the learning data of which the evaluated value is greater than or equal to or less than a certain threshold value, the learning data at the top or bottom of the evaluated value, or the learning data of which the evaluated value is in a certain range.

In addition, it is also possible to select the learning data by calculating the evaluated value with respect to a distance between the learning data pieces or a set of learning data pieces, and by repeating the exclusion of the learning data on the basis of the evaluated value.

In a case where a label is applied to the learning data, a method for selecting the learning data such that a difference in the ratio of each label is less than or equal to a certain threshold value, or a method for selecting the learning data at a ratio different for each label can also be adopted.

Further, from the viewpoint of the learning, in a case where a distance between the characteristic vector calculated from the individual data and the representative vector is excessively short, a contribution to the learning is low and effectiveness is low, and in a case where the distance is excessively long, it is difficult to make the distance short by the learning.

Accordingly, it is possible to expect to perform efficient and highly accurate learning by calculating the distance between the characteristic vector and the representative vector, and by remaining only the individual data of which the distance is in a certain range.

The processing branches in accordance with whether the individual model in the server corresponding to the learning data selected in S4020 is stored in the learning data storage unit 1290 in the server (S4030).

In a case where there is the individual model in the server, the encoded individual model in the server is read from the learning data storage unit 1290 in the server and is decoded (S4050). In a case where there is no individual model in the server, the individual model in the server is generated (S4040).

The individual model in the server is generated by inputting the learning data to the common model to generate the characteristic vector, and by performing a statistical operation such as an average value and a median value with respect to the obtained characteristic vector.

As the common model used in such a case, a preliminary learning model when starting the associative learning may be stored and used, or the latest common model received by the training data management server 1200 in S2210 may be used. Note that, the individual model in the server may be initialized with random weight without using the data.

The common model and the individual model in the server are updated by using the learning data selected in S4020, the individual model in the server acquired in S4040 or S4050, and the common model acquired in S2210 (S2220).

The common model and the individual model in the server are learned by defining a loss function with respect to the model, and by searching for weight that minimizes the function.

The loss function is defined as a loss with respect to an ideal relationship by modeling how ideal the relationship between the common model and the individual model in the server.

For example, in the case of using the representative vector of the characteristic vector generated from the data as the individual model in the server, the ideal relationship is that the characteristic vector generated by inputting all the data pieces to the common model is the same as the representative vector. Accordingly, as the loss function, the sum of the square of the distance between the characteristic vector and the representative vector, the ratio of a function based on an inner product of the characteristic vector and the representative vector, and the like are adopted.

By minimizing such a loss function, the characteristic vector approaches the representative vector, and the ideal relationship is formed.

In addition, in the case of using a deep learning model such as convolutional neural networks (CNN) or Transformer as the common model, an optimization method such as a stochastic gradient descent is applied, and the loss function is minimized.

The weight of the common model and the individual model is searched. Note that, when performing the model learning, a noise may be applied to the individual data, and then, the learning may be performed.

It is known that the individual data used in the learning can be presumed from a learning result in the client device 1000, but the presumption of the individual data can be difficult due to the application of the noise. As described above, the common model and the individual model in the server are learned.

Next, a processing procedure of the learning S2030 in the client device will be described with reference to FIG. 5.

First, the client device 1000 decodes the individual data stored in the individual data storage unit 1090 by the data decoding unit 1040 (S5010).

In order to decode the individual data, the private key when performing the encryption is required. The private key is acquired or generated by the same procedure as S5010, and is decoded.

Next, the learning data used in the learning in the client device is selected from the individual data stored in the individual data storage unit 1090 (S5020). The learning data can be selected by randomly extracting a predetermined number of individual data pieces from the individual data storage unit 1090.

Note that, the individual data can also be selected by calculating the evaluated value for each individual data piece, and by selecting the individual data of which the evaluated value is greater than or equal to or less than a certain threshold value, the individual data at the top or bottom of the evaluated value, or the individual data of which the evaluated value is in a section set by a threshold value.

In addition, it is also possible to select the individual data by calculating the evaluated value with respect to a distance between the individual data pieces or a set of individual data pieces, and by repeating the exclusion of the individual data on the basis of the evaluated value.

Further, from the viewpoint of the learning, in a case where a distance between the characteristic vector calculated from the individual data and the representative vector is excessively short, a contribution to the learning is low and effectiveness is low, and in a case where the distance is excessively long, it is difficult to make the distance short by the learning.

Accordingly, it is possible to expect to perform efficient and highly accurate learning by calculating the distance between the characteristic vector and the representative vector, and by remaining only the individual data of which the distance is in a certain range.

The processing branches in accordance with whether the individual model is stored in the individual data storage unit 1090 (S5030). In a case where there is the individual model, the encoded individual model is read from the individual data storage unit 1090 and is decoded (S5050).

In a case where there is no individual model, the individual model is generated (S5040). The individual model can be generated by inputting the individual data to the common model to generate the characteristic vector, and by performing a statistical operation such as an average value and a median value with respect to the obtained characteristic vector.

As the common model used in such a case, a preliminary learning model when starting the associative learning may be stored and used, or the latest common model received by the client device 1000 in S2020 may be used. Note that, the individual model may be initialized with random weight without using the individual data.

The common model and the individual model are updated by using the learning data selected in S5010, the individual model acquired in S5040 or S5050, and the common model received in S2020 (S5060).

The model is updated by defining a loss function with respect to the model, and by searching for weight that minimizes the function. The loss function is defined as a loss with respect to an ideal relationship by modeling how ideal the relationship between the individual data and the common model and the individual model with respect to the individual data.

For example, in the case of using the representative vector of the characteristic vector generated from the individual data as the individual model, the ideal relationship is that characteristic vector generated by inputting all the individual data pieces to the common model is the same as the representative vector.

Accordingly, the sum of the square of the distance between the characteristic vector and the representative vector is adopted as the loss function, by minimizing the loss function, the characteristic vector approaches the representative vector, and the ideal relationship is formed.

In addition, in the case of using a deep learning model such as convolutional neural networks (CNN) or Transformer as the common model, an optimization method such as a stochastic gradient descent is applied, and the weight of the common model and the individual model that minimizes the loss function is searched.

Note that, when performing the model learning, a noise may be applied to the individual data, and then, the learning may be performed. It is known that the individual data used in the learning can be presumed from the learning result in the client device 1000, but the presumption of the individual data can be difficult due to the application of the noise.

As described above, the common model and the individual model are learned.

Next, a processing procedure of the model update S2140 will be described with reference to FIG. 6.

First, it is verified whether the client device 1000 that has transmitted the learning result is a correct client device selected in S2110 (S6010).

In S6010, a terminal number, an IP address, or the like is recorded as information for identifying the client device selected in S2110, and is matched with the client device that has transmitted the learning result in S2130.

In the case of a correct client device, the process proceeds to the processing subsequent to S6010, and in the case of an incorrect client device, the client device is excluded from the model update.

This is performed in order to prevent an attack referred to as a model poisoning attack that degrades the accuracy of the model by the client device transmitting a wrong learning result.

Next, the class of the client device is classified by using the individual model received from the client device 1000, and the individual model and the attribute information transmitted from the training data management server 1200 (S6020). Here, the class is determined in accordance with the attribute of the individual model transmitted from the training data management server . For example, as the class of the gender, two classes of male and female are considered.

In addition, the class can also be determined from a plurality of attributes. For example, four classes of Male×Black eye, Male×Eye other than Black Eye, Female×Black eye, and Female×Eye other than Black Eye can be considered from the gender and the color of the eye.

The class classification is performed on the basis of the individual model transmitted from the training data management server or the evaluated value indicating a relationship between model specific to each attribute (an attribute individual model), which is obtained by averaging the individual models, and the individual model of the client device.

As the evaluated value, a Euclidean distance or a Mahalanobis distance between two individual models or the degree of cosine similarity can be used.

As a classification method, a method for classifying into the class of the individual model in the server at the top or bottom of the evaluated value or the attribute individual model, a method for classifying in accordance with the ratio of the individual model in the server of which the evaluated value is greater or less than or equal to a certain threshold value or the attribute individual model, and the like can be adopted.

In addition, a method in which a classification model such as a decision tree or a neural network is learned by using the individual model transmitted from the training data management server, and the individual model transmitted from the client device is classified by using the classification model can also be adopted.

Note that, it is not necessary to classify the individual model into a single class, and it is also possible to stochastically classify the individual model.

Next, the common model received from the plurality of client devices 1000 and training data management server is aggregated (S6030). In such processing, the weight of a single common model is calculated from the weight of a plurality of common models learned separately in each of the client devices and the training data management server.

As a calculation method, a method for simply obtaining the average of the weights, a method for performing averaging after weighting based on a classification result in S6030, and the like can also be adopted.

As a weighting method based on the classification result, a method in which, first, an average is calculated in each classified class, and then, an average is calculated in all the classes, a method for performing weighting by the ratio of the class occupied by the individual model or the inverse number thereof, and the like can be adopted.

The individual model received from the plurality of client devices 1000 is optimized (S6040). For example, in the case of using the representative vector with respect to the characteristic vector generated from the individual data as the individual model, the representative vector of each of the client devices and the training data management server is aggregated with respect to the training server.

Since the representative vector is a vector positioned at the center when the individual data of each individual is input to the common model to generate the characteristic vector, in a case where a distance between representative vectors of two individuals is short, it is difficult to identify the two individuals with the characteristic vector, and identification capability is degraded.

Accordingly, it is ideal that a distance between all the representative vectors is greater than or equal to a certain value. Such properties are expressed in the form of a loss function, and a representative vector for decreasing the loss function is obtained, and thus, the representative vector can be optimized.

For example, the value of a margin between the representative vectors is defined, and when the distance between the representative vectors is less than the margin, the square of the margin and the distance between the representative vectors is calculated, and the sum thereof is obtained, and thus, the loss function can be defined.

In a case where the loss function is 0, an ideal situation is obtained in which the distance between all the representative vectors is greater than or equal to the margin.

On the other hand, in a case where most of the client devices that participate in the rounds of all the attributes have the same attribute, only the representative vector of the attribute spreads, and there is a possibility that a difference occurs in the authentication accuracy between the attribute and the other attributes.

In order to prevent such a problem, the loss function based on the class classified in S6030 is added when optimizing the representative vector.

As the loss function to be added, for example, a function of a difference between the attributes of the maximum value, the average, and the minimum value of the distances between the representative vectors, a function indicating a difference in the distribution of the representative vectors between the attributes, a function of a difference in the dispersion of the representative vectors between the attributes, and the like can be adopted.

Finally, the common model aggregated in S6030 is stored in the common model storage unit 1190 (S6050). As described above, the common model and the individual model are updated, and the learned common model is stored in the common model storage unit 1191.

Next, a processing procedure of the individual model storage S2250 in the training data management server 1200 will be described with reference to FIG. 7.

First, the individual model transmitted by the training server in S2150 is encoded (S7010). The encryption is performed by preparing a private key with a certain method, and by utilizing the private key.

The individual model encoded in S7010 is stored in the learning data storage unit 1290 in the server (S7020). As described above, the individual model that has been transmitted from the training server is encoded, and then, can be safely stored in the learning data storage unit 1290 in the server.

Next, a processing procedure of the individual model storage S2060 in the client device 1000 will be described with reference to FIG. 8.

First, the individual model transmitted by the server in S2150 is encoded (S8010). The encryption is performed by preparing a private key with a certain method, and by utilizing the private key, as with the individual data encryption in S3010.

The individual model encoded in S8010 is stored in the individual data storage unit 1090 (S8020). As described above, the individual model that has been transmitted from the server is encoded, and then, can be safely stored in the individual data storage unit 1090.

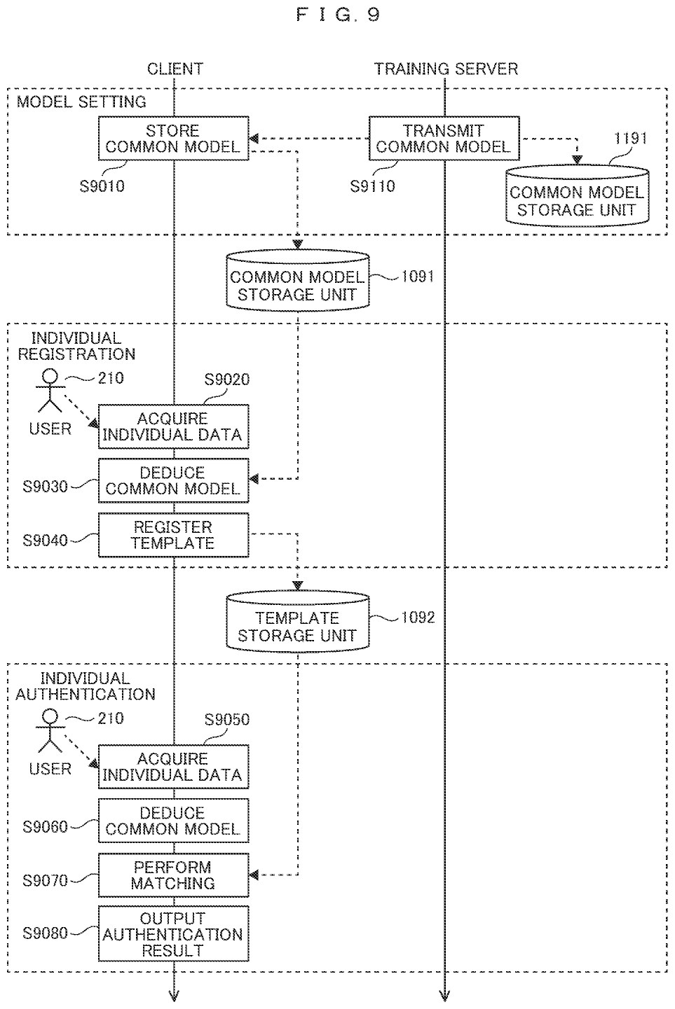

Next, a processing procedure when applying the common model learned by the procedure in FIG. 2 to the individual authentication will be described with reference to FIG. 9.

The processing procedure is configured in three steps of model setting, individual registration, and individual authentication. First, in the model setting, the training server 1100 obtains the common model from the common model storage unit 1191 to transmit to the client device (S9110).

The client device 1000 receives the common model to store in the common model storage unit 1091 (S9010). S9010 is not performed each time when the individual authentication is performed, but is performed by a developer or a manager at a timing when the operation of the authenticate system is newly started or when the version of the authenticate system is upgraded.

Next, in the individual registration, the individual data is acquired from the user 210 (S9020), and the individual data is input to the common model stored in the common model storage unit 1091 to generate the characteristic vector (S9030).

The template for registration is generated from the obtained characteristic vector, and is stored in the template storage unit 1092 (S9040).

The template is information for registration generated from the individual data, and the characteristic vector may be directly used as a template.

Note that, a certain template protection technology may be applied when generating the template to prepare a countermeasure for preventing the leakage of the original individual data from the template.

Finally, in the individual authentication, the individual data is acquired from the user 210 (S9050), and is input to the common model stored in the common model storage unit 1091 to generate the characteristic vector (S9060).

The obtained characteristic vector and the template stored in the template storage unit 1092 are matched with each other, and as a matching result, the degree of similarity, the degree of dissimilarity, and the like are calculated (S9070).

For example, in the case of performing the authentication on the basis of the distance between the characteristic vectors, a Hamming distance or a Euclidean distance between the characteristic vectors is calculated to be set as the degree of dissimilarity.

A result of an authentication success or an authentication failure is obtained by using threshold value processing or the like in such a matching result, and is output (S9080). Note that, the matching result is not limited to a continuous value such as the degree of similarity or the degree of dissimilarity, and in the case of generating the template by using the template protection technology, a binary value of the authentication success or the authentication failure may be obtained as the matching result. In this case, the threshold value processing is not required, and the matching result is directly output as an authentication result. As described above, the individual authentication can be performed by utilizing the common model learned on the basis of the processing in FIG. 2.

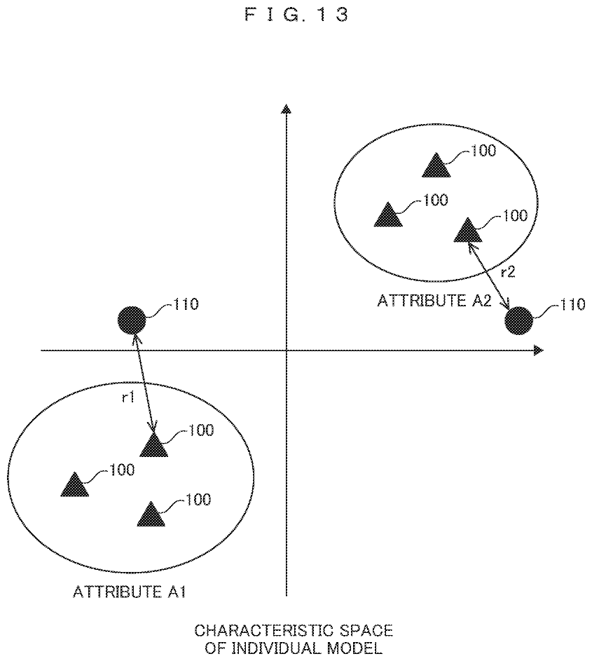

Client classification performed in S6020 of FIG. 6 will be described with reference to FIG. 13.

FIG. 13 illustrates an example of a client classification method assuming that one point on a two-dimensional characteristic space represents the individual model.

In the example illustrated in FIG. 13, a client is classified into the attribute of the individual model 100 of the training data management server closest to the individual model 110 of the client.

In this case, a client corresponding to the individual model of the client connected to an individual model of a training data management server of an attribute A1 by the shortest distance r1 is classified into the attribute A1.

Similarly, a client corresponding to the individual model connected to an individual model of a training data management server of an attribute A2 by the shortest distance r2 is classified into the attribute A2. As described above, the client can be classified by using the individual model of the training data management server and the individual model of the client.

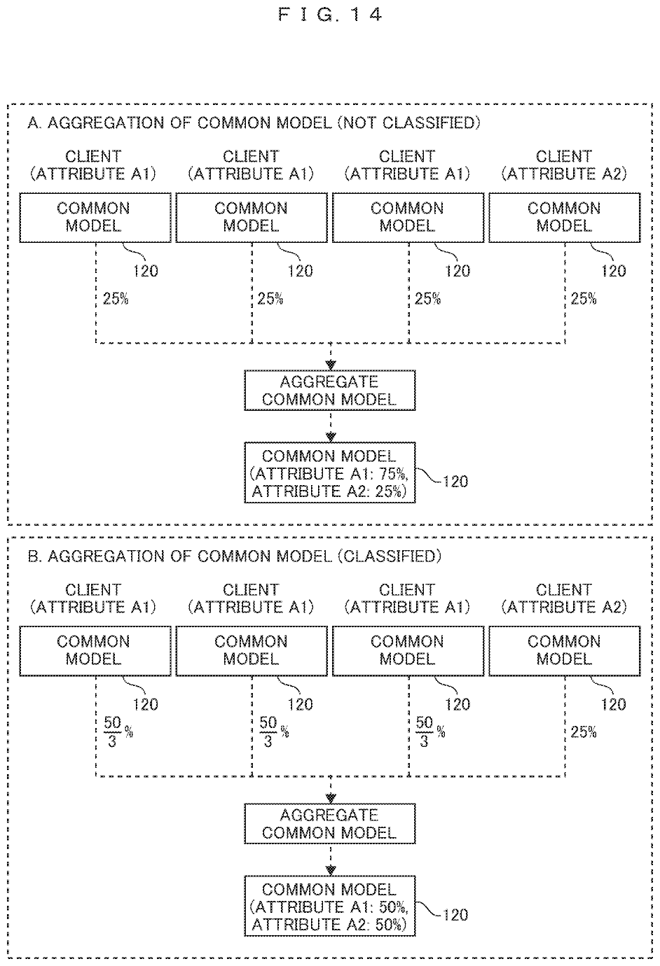

The aggregation of the common model (S6030) due to the presence or absence of the client classification performed in S6020 of FIG. 6 will be described with reference to FIG. 14.

A in FIG. 14 illustrates an example of the aggregation of the common model in the case of not classifying the client, and B in FIG. 14 illustrates an example of the aggregation of the common model in the case of classifying the client.

In FIG. 14, the aggregation of the common models of a total of four clients including three clients having the attribute A1 and one client having the attribute A2 is performed by averaging.

In the case of not classifying the client, the averaged common model is greatly affected by the common model learned by the client of the attribute A1. In the example of FIG. 14, in the aggregated common model, a contribution rate of the common model learned by the data of the attribute A1 is biased to 75%, and a contribution rate of the common model learned by the data of the attribute A2 is biased to 25%.

On the other hand, in the case of classifying the client, a weighting average considering the attribute of the learning data of each of the common models can be performed. In the example of FIG. 14, averaging is performed by applying weight of 50/3% to the common model learned by the data of the attribute A1 and weight of 50% to the common model learned by the data of the attribute A2, and thus, the contribution rate of each of the attributes A1 and A2 with respect to the common model after the aggregation can be 50%.

Even in a case where the client is not classified, the weight with respect to the common model of each of the clients can be changed to an arbitrary value, but in a case where the attribute is unknown, weighting considering the contribution rate with respect to each of the common models after the aggregation is not available.

As described above, by classifying the client, it is possible to perform the aggregation of the common model considering the attribute.

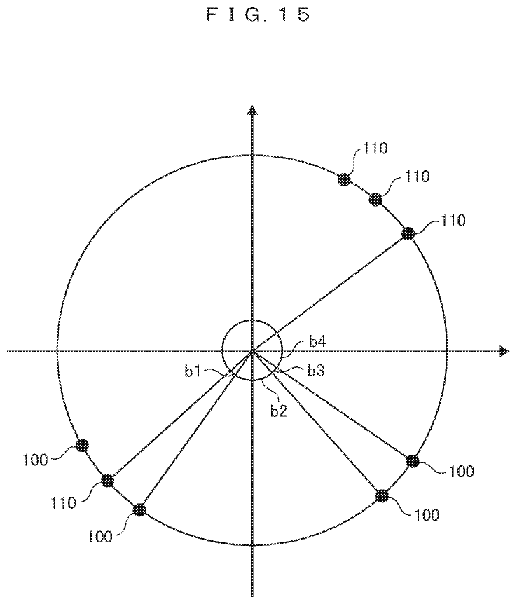

The optimization of the individual model performed in S6040 of FIG. 6 will be described with reference to FIG. 15.

FIG. 15 illustrates an example of the optimization of the individual model assuming that one point on a unit circle in a two-dimensional characteristic space represents the individual model.

In the example of FIG. 15, the optimization can be performed by moving the point of the individual model such that angles b1, b2, . . . between two individual models increase. As described above, the individual model can be optimized.

### SECOND EXAMPLE

In a second example, the processing of the training server and the processing of the training data management server in the first example are performed by a single server.

In the first example, by separating the training server and the training data management server, the machine learning using this machine learning method can be attained even in a case where an operator of the associative learning and a data provider for considering fairness are different. As a result, the privacy of the training data management server can be protected from a management subject of the training server.

In the second example, instead of losing such a merit, it is possible to reduce overhead on communication between both servers and to more effectively utilize a calculation resource of the server by unifying the training server and the training data management server.

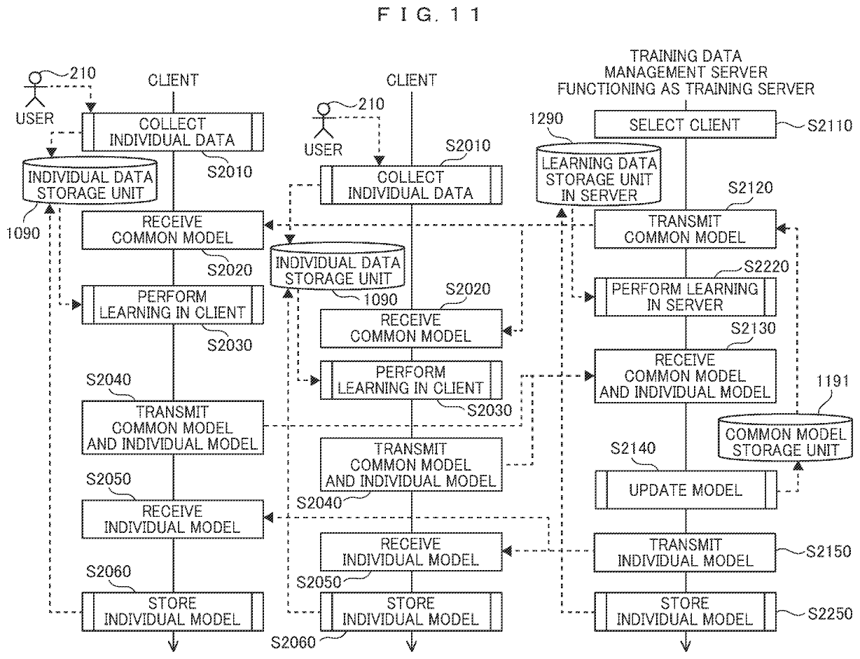

Here, only a difference from FIG. 2 will be described with reference to FIG. 11.

In FIG. 11, a single training server also has the function of the training data management server. Accordingly, transmission/reception processing of the model between the training server and the training data management server is not required, and thus, the processing corresponding to S2210, S2230, and S2240 is not performed. The other processing is the same as that in FIG. 2.

In FIG. 11, the learning S2220 in the server is performed after the client device selection of S2110 and common model transmission of S2120 are performed, but in a case where the weight of the common model used in the learning in the server is the same as the weight of the common model that is transmitted to each of the client devices, the learning S2220 in the server may be performed at any timing before and after the client device selection S2110 and the common model transmission S2120.

In addition, S2220 can also be performed in parallel with S2110 and S2120. By performing parallel processing, it is possible to reduce time required for one round (a set of processing from the client device selection S2110 to the individual model transmission S2150), compared to sequential processing.

### THIRD EXAMPLE

In a third example, the transmission/reception of the model in the first example is performed through the shuffle server. By using the shuffle server, it is difficult for the server to associate the client device with the individual model and the share model, and the safety of the associative learning is improved.

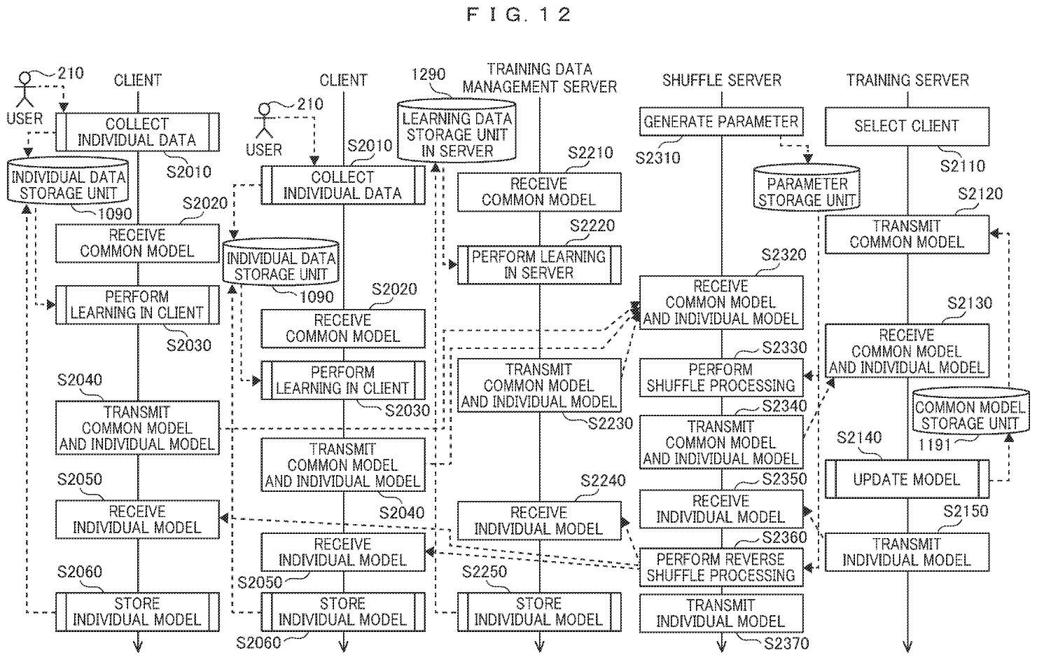

Here, only a difference from FIG. 2 will be described with reference to FIG. 1 and FIG. 12.

FIG. 1 is a diagram including the configuration of the shuffle server. In FIG. 1, 1300 is the shuffle server, and includes a parameter generation unit 1310, a shuffle processing unit 1320, and a parameter storage unit 1390. Hereinafter, each unit will be described.

The parameter generation unit 1310 generates a parameter that is used in the case of performing the order shuffle or the application of the identifier with respect to the received individual model or common model (S2310).

As the parameter generated in S2310, a correspondence table of the identifier of the client device when the learning result is received from the client device and the identifier when the learning result is transmitted to the training server can be adopted.

The shuffle processing unit 1320 performs shuffle processing (S2330 and S2360) described below. The parameter storage unit 1390 stores the parameter generated in the parameter generation unit 1310.

In the third example, first, the common model and the individual model transmitted from the client device and the training data management server in S2040 and S2230 are received by the shuffle server 1300 (S2320).

In this case, the client device or the training data management server may encode the transmission data in a form that is difficult for the shuffle server to decode. For example, by performing the encryption using the public key of the training server, it is possible to transmit such data to the training server while keeping the common model and the individual model confidential from the shuffle server.

The shuffle server 1300 acquires the parameter from the parameter storage unit 1390, and performs the shuffle processing with respect to the received common model or individual model (S2330).

Here, the shuffle processing is processing for keeping a correspondence relationship between the client device and the common model and the individual model confidential, and processing of randomly switching the identifier provided in advance in each of the client devices, processing of applying a new identifier to each of the client devices, or the like can be applied. After the shuffle processing, the common model and the individual model are transmitted to the training server (S2340).

Next, the shuffle server 1300 receives the updated individual model transmitted from the training server 1100 (S2350). In this case, the training server may encode the transmission data in a form that is difficult for the shuffle server to decode.

For example, it is possible to perform the encryption using the public key of each of the client devices, or to perform the encryption by receiving the encoded common key at the same time when the common model and the individual model are received, and by using the common key.

Processing reverse to S2330 is performed with respect to the received individual model, and the correspondence relationship between the individual model and the client device is returned to the same state as that when performing the reception in S2320 (S2360). After that, the individual model is transmitted to each of the corresponding client devices and the corresponding training data management server (S2370).

As described above, in the third example, it is possible to construct a high-accuracy common model while improving the safety of the associative learning through the shuffle server and reducing a difference in the authentication accuracy between the attributes.

In the examples described above, the client device is classified on the training server by using the individual model transmitted from the training data management server and the individual model transmitted from the client device, and the aggregation of the common model and the optimization of the individual model according to the classification result are performed.

According to the examples described above, in the associative learning for the individual authentication, it is possible to reduce a difference in the authentication accuracy that occurs between the individuals having different attributes.

In the examples described above, it is assumed that the user of the client device is an individual, but the examples described above can also be applied to a case where the user of the client device is an institute such as a company.

What is claimed is:

1. A learning system updating a model on the basis of learning data, the system comprising:
a plurality of client devices;
a training data management server; and
a training server,
wherein the training server manages a common model,
the client device and the training data management server manage individual data,
generate an individual model different for each individual from the common model and the individual data,
share the common model and the individual model with the training server, and
receive the common model from the training server, update the common model and the individual model on the basis of the individual data, and transmit the updated common model and individual model to the training server, and
the training server classifies the common model and the individual model transmitted from the plurality of client devices on the basis of the individual model transmitted from the training data management server, and updates the common model and the individual model in accordance with a classification result.

2. The learning system according to claim 1,
wherein an attribute is applied to the individual model, and
the training server classifies the common model and the individual model transmitted from the plurality of client devices for each attribute, on the basis of the attribute applied to the individual model transmitted from the training data management server.

3. The learning system according to claim 1,
wherein the training server
classifies the common model transmitted from the plurality of client devices on the basis of the individual model transmitted from the training data management server, and
updates the common model by obtaining a weighted average for each cluster of the classification result.

4. The learning system according to claim 1,
wherein the training server
classifies the individual model transmitted from the plurality of client devices on the basis of the individual model transmitted from the training data management server, and
updates the individual model by using a gradient obtained by differentiating a function calculated for each cluster of the classification result with a parameter of the model.

5. The learning system according to claim 1,
wherein the training server
updates the common model and the individual model by aggregating the common model in accordance with the classification result to optimize the individual model, and
transmits the optimized individual model to the client device.

6. The learning system according to claim 1, further comprising
a shuffle server,
wherein the client device and the training data management server
receive the common model from the training server,
update the common model and the individual model on the basis of the individual data, and
transmit the updated common model and individual model to the shuffle server,
the shuffle server performs random order shuffle or an application of an identifier with respect to the received common model and individual model, and transmits the common model and the individual model to the training server, and
the training server classifies the common model and the individual model transmitted from the plurality of client devices on the basis of the common model and the individual model transmitted from the shuffle server, and updates the common model and the individual model according to the classification result.

7. The learning system according to claim 6,
wherein the client device and the training data management server randomly generate a one-time common key, and encode the common model and the individual model with a public key of the training server to transmit to the shuffle server,
the shuffle server performs the random order shuffle or the application of the identifier with respect to the encoded common model and individual model that are received, and transmits the common model and the individual model to the training server, and
the training server decodes the received common model and the individual model with a private key of the training server, classifies the common model and the individual model transmitted from the plurality of client devices on the basis of the individual model transmitted from the training data management server, and updates the common model and the individual model according to the classification result.

8. A learning system updating a model on the basis of learning data, the system comprising:
a plurality of client devices; and
a training server,
wherein the training server manages a common model and individual data,
the client device manages the individual data,
the client device and the training server
generate an individual model different for each individual from the common model and the individual data, and
share the common model and the individual model with the training server and the client device,
the client device receives the common model from the training server, updates the common model and the individual model on the basis of the individual data, and transmits the updated common model and individual model to the training server, and
the training server
creates the individual model from the individual data and the common model, and updates the common model and the individual model on the basis of the individual data, and
classifies the common model and the individual model transmitted from the plurality of client devices on the basis of the individual model corresponding to the individual data, and updates the common model and the individual model according to a classification result.

9. The learning system according to claim 8,
wherein an attribute is applied to the individual model, and
the training server classifies the common model and the individual model transmitted from the plurality of client devices for each attribute, on the basis of the attribute applied to the individual model.

10. The learning system according to claim 8,
wherein the training server
classifies the common model transmitted from the plurality of client devices on the basis of the individual model, and
updates the common model by obtaining a weighted average for each cluster of the classification result.

11. The learning system according to claim 8,
wherein the training server
classifies the individual model transmitted from the plurality of client devices on the basis of the individual model, and
updates the individual model by using a gradient obtained by differentiating a function calculated for each cluster of the classification result with a parameter of the model.

12. The learning system according to claim 8,
wherein the training server
updates the common model and the individual model by aggregating the common model in accordance with the classification result to optimize the individual model, and
transmits the optimized individual model to the client device.

13. A learning method for updating a model on the basis of learning data by using a learning system including a plurality of client devices and a training server, the method comprising:
allowing the training server to manage a common model and individual data;
allowing the client device to manage the individual data;
allowing the client device and the training server to generate an individual model different for each individual from the common model and the individual data;
allowing the client device and the training server to share the common model and the individual model with the training server and the client device;
allowing the client device to receive the common model from the training server, to update the common model and the individual model on the basis of the individual data, and to transmit the updated common model and individual model to the training server; and
allowing the training server to create the individual model from the individual data and the common model, to update the common model and the individual model on the basis of the individual data, to classify the common model and the individual model transmitted from the plurality of client devices on the basis of the individual model corresponding to the individual data, and to update the common model and the individual model according to a classification result.

14. The learning method according to claim 13,
wherein an attribute is applied to the individual model, and
the training server is allowed to classify the common model and the individual model transmitted from the plurality of client devices for each attribute, on the basis of the attribute applied to the individual model.

15. The learning method according to claim 14,
wherein the attribute applied to the individual model indicates a characteristic of the individual including a gender or a color of a skin.
